(19) United States
(12) Patent Application Publication
(10) Pub. No.: US 2007/0137883 A1
(43) Pub. Date: Jun. 21, 2007

(54) Bird deterring device and related clamping means

(76) Inventor: Sopragasen Naidoo, Roodepoort (ZA)

Correspondence Address: MERCHANT & GOULD PC, P.O. BOX 2903, MINNEAPOLIS, MN, 55402-0903, US

(21) Appl. No.: 10/575,604

(22) PCT Filed: Dec. 23, 2003
(86) PCT No.: PCT/ZA03/00190

§ 371 Date: Apr. 13, 2006

(51) Int. Cl. H01R 4/70

(52) U.S. Cl. 174/138 F

(57) ABSTRACT

The invention provides for a device for deterring birds from overhead cables such as power lines, which device includes a clamping means for clamping the device on the overhead cable, the clamping means including a first member having a hook portion for hooking over the power line and a second member biased towards the hook portion, wherein said biased member includes a biasing means, and at least one vane set rotatably attached to the clamping means wherein the first and second members are displaceable relative to each other between a first loaded position, wherein the biasing means is loaded, and a second clamped position, wherein the biasing means is at least partially unloaded thereby clamping the power line between the first member and the second member. The invention further provides for a method of deploying said clamping means onto an overhead cable.

### FIELD OF THE INVENTION

The invention is in the field of devices configured to keep animals away from potentially dangerous objects, specifically overhead cables such as power lines.

### BACKGROUND TO THE INVENTION

Urban expansion has led to a dramatic increase in the number of overhead cables such as power lines. These power lines often expose a risk to wildlife, especially birds.

The placement of traditional deterring devices is often a dangerous and ineffective exercise with the wind moving the devices once they have been placed.

The inventor believes a need exists for a device that is clearly visible to wildlife and at the same time easy to place and not easily moved by the wind or other movement on the power lines.

### SUMMARY OF THE INVENTION

According to an aspect of the invention there is provided a device for deterring birds from overhead cables such as power lines, which device includes;

a clamping means for clamping the device on the overhead cable, the clamping means including

a first member having a hook portion for hooking over the power line; and

a second member biased towards the hook portion, wherein said biased member includes a biasing means, and

at least one vane set rotatably attached to the clamping means wherein the first and second members are displaceable relative to each other between a first loaded position, wherein the biasing means is loaded, and a second clamped position, wherein the biasing means is at least partially unloaded thereby clamping the power line between the first member and the second member.

The vane set may be fluorescent thereby to increase the visibility of the vanes to the birds.

The vanes of the vane set may be alternatingly coloured with a first colour and a second colour.

The vanes of the vane set may be alternatingly coloured black and white thereby to be visible to the birds by day and by night.

The vane set may be reflective.

The vanes may be configured to rotate in response to the wind.

The vanes may be configured to rotate in response to vibrations from the power line.

The vanes may be rotatably attached to the clamping means by a suspension means.

The suspension means may be in the form of a rod.

The suspension means may be in the form of a flexible rod which is rotatable attached at one end region to the clamping means and at its other end region to the vane set. The inventor believes this rotatable attachment to be advantages as it results in more efficient rotation of the vanes by wind and vibrations from the power lines.

The biasing means of the second member may include a spring.

The second member may include a securing means configured to keep the second member in the first position ready for clamping onto the overhead cables.

The second member may include a securing means configured to keep the second member in the second clamped position.

The second member may include a ratchet configured to assist in keeping the second member in the second clamped position.

The second member may include a soft portion that assists in clamping the clamping means on the cable.

The soft portion may inhibit damage to the cable.

The soft portion may be an insert.

The first member may be substantially C-shaped.

The lower section of the C-shape may be configured to house the second member in the first position when loaded.

The upper section of the C-shape may be the hook portion for hooking over the power line.

At least a part of the hook portion may include a soft portion that assists in clamping the clamping means on the cable.

The soft portion of the hook portion may inhibit damage to the cable.

The soft portion of the hook portion may be an insert.

The first member may include a slot for receiving the securing means of the second member.

The securing means may be configured to be released from the first position by remote activation.

The first member may include a ratchet configured to assist in keeping the second member in the second clamped position.

According to another aspect of the invention, there is provided a clamping means for clamping objects to overhead cables such as power lines, said clamping means including;

a first member having a hook portion for hooking over the overhead cable;

a second member biased towards the hook portion; and

biasing means for biasing the second member towards the hook portion; and

wherein the first and second members displaceable relative to each other between a first loaded position, wherein when the biasing means is loaded, and a second clamped position, wherein the biasing means is at least partially unloaded thereby clamping the power line between the first member and the second member.

The biasing means of the second member may include a spring.

The second member may include a securing means configured to keep the second member in either the first or second position.

The first member may be substantially C-shaped.

The lower section of the C-shape may be configured to house the second member in the first position when loaded.

The upper section of the C-shape may be the hook portion for hooking over the overhead cable.

The first member may include a slot for receiving the securing means of the second member.

The securing means may be configured to be released from the first position by remote activation.

The first member may include a ratchet configured to assist in keeping the second member in the second position.

The first member may include a ratchet configured to assist in keeping the securing means in the second position.

According to yet another aspect of the invention, there is provided a device for deterring birds from overhead cables such as power lines that includes at least one vane set.

The vane set may be fluorescent thereby to increase the visibility of the vanes to the birds.

The vanes of the vane set may be coloured thereby to be visible to the birds by day and by night.

The vane set may be reflective.

The vanes may be configured to rotate in response to the wind.

The vanes may be configured to rotate in response to vibrations from the power line.

The vanes may be rotatably attached to the clamping means by a suspension means.

According to yet another aspect of the invention there is provided a method of deploying a clamping means including:

a first member having a hook portion for hooking on to the cable;

a second member biased towards the hook portion; and

biasing means for biasing the second member toward the hook portion wherein the first and second members are displaceable relative to each other between a first loaded position, wherein the biasing means is loaded, and a second clamped position, wherein the biasing means is at least partially unloaded thereby clamping the power line between the first member and the second member;

said method including;
hooking the clamping means onto the cable; and
actuating the displacement of the first and second members relative to each other.

The biasing means of the second member may include a spring.

The second member may include a securing means configured to keep the second member in either the first or second position, which securing member is released thereby actuating the relative displacement of the first and second members.

The actuation of the displacement of the first and second members relative to each other may be by remote control.

The actuation by remote control may include a remote control vehicle configured to run along the length of the cable and to actuate said displacement at predetermined intervals.

The actuation by remote control may include a remote control vehicle configured to run along the length of the cable and to actuate said displacement at the discretion of a user.

### DETAILED DESCRIPTION OF DRAWINGS

The invention will now be described, by way of non-limiting example, with reference to the accompanying diagrammatic drawings wherein:

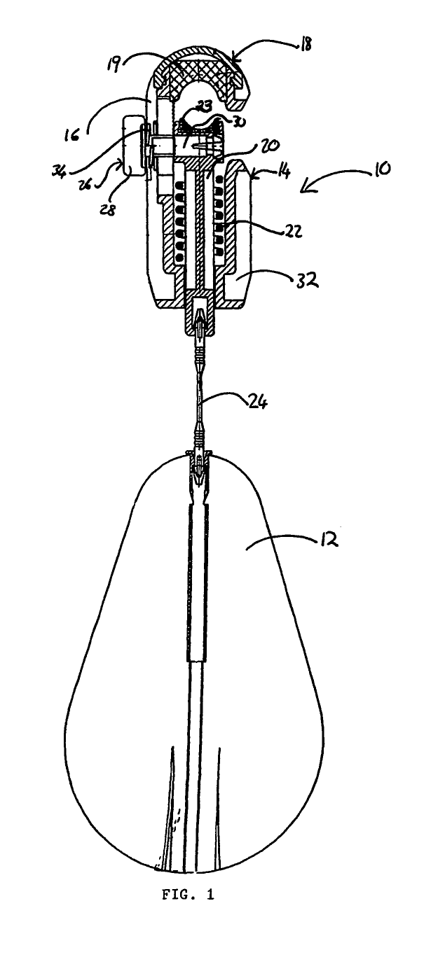

FIG. 1 shows a cross-section through the bird deterring device;

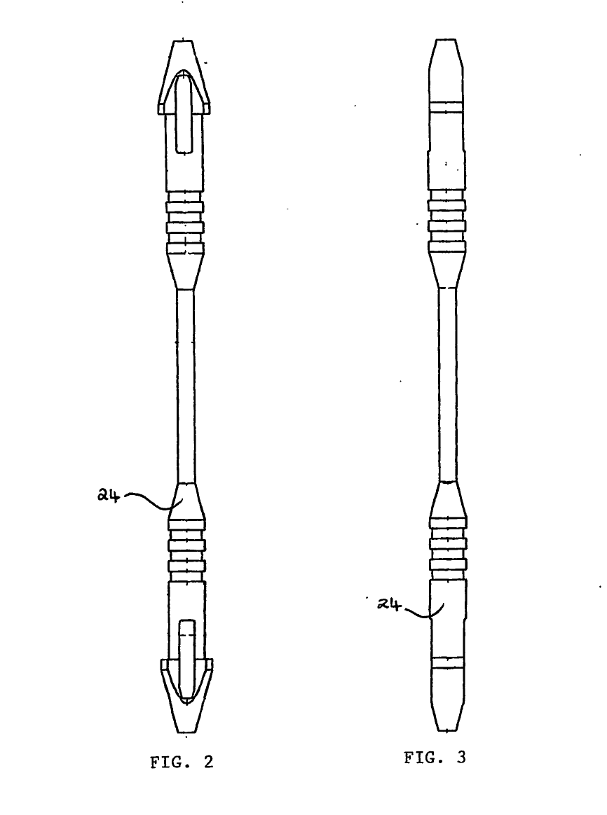

FIG. 2 shows a plan view of the suspension means;

FIG. 3 shows a cross-section through the suspension means;

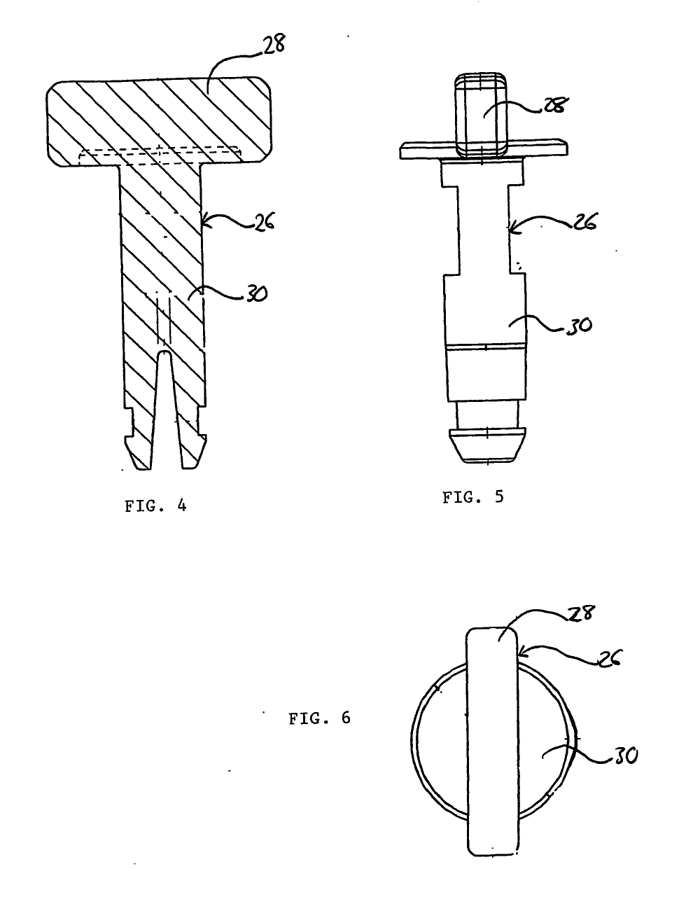

FIG. 4 shows a cross-section through the securing means;

FIG. 5 shows a plan view of the securing means;

FIG. 6 shows a top view of the securing means;

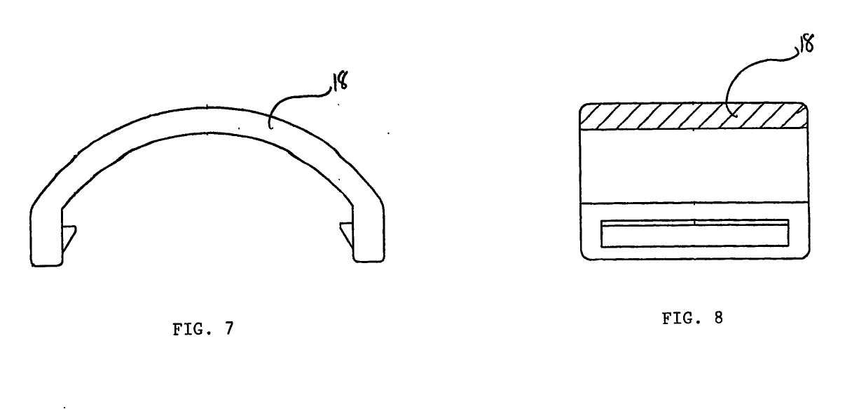

FIG. 7 shows a side view of the upper section of the C-shaped first member;

FIG. 8 shows a cross section of the upper section of the C-shaped first member;

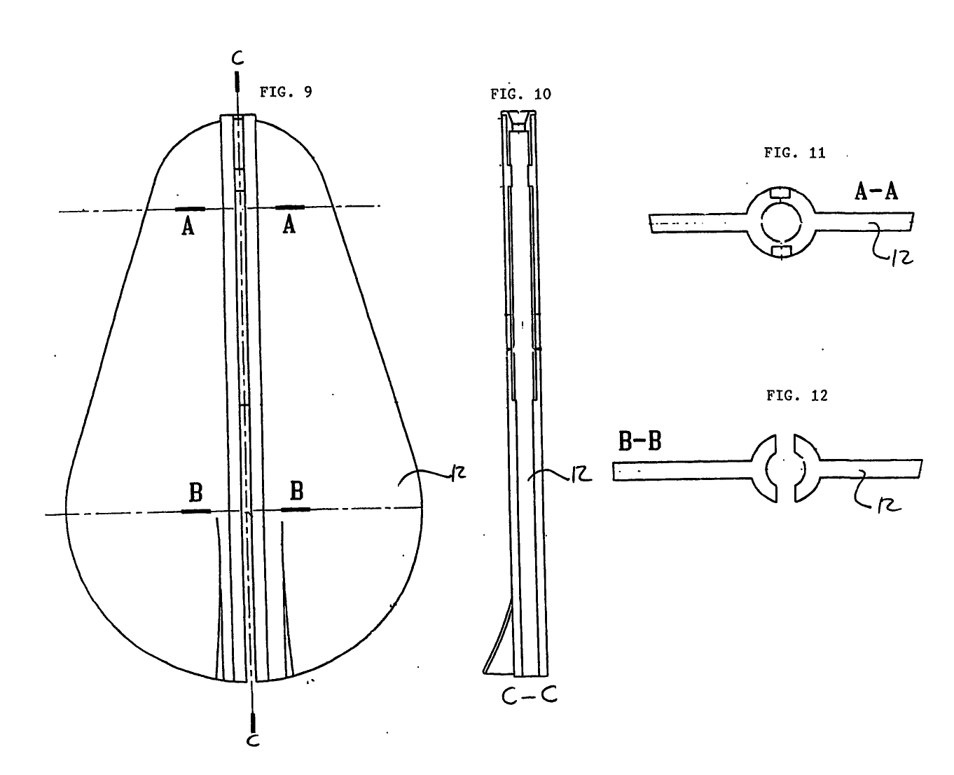

FIG. 9 shows a plan view of one of the vanes,

FIG. 10 shows a cross-section through one of the vanes on level C-C;

FIG. 11 shows a section through the vane in FIG. 9 on the level A-A;

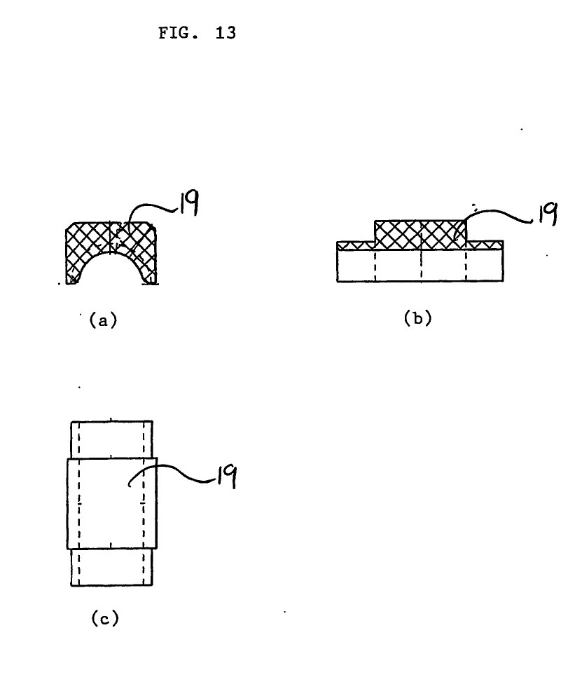

FIG. 12 shows a section through the vane in FIG. 9 on the level B-B;

FIGS. 13[a-c] show an insert in one embodiment of the upper section of the C-shaped first member, with [a] being an end-on section through, [b] a side-on section through and [c] a plan view;

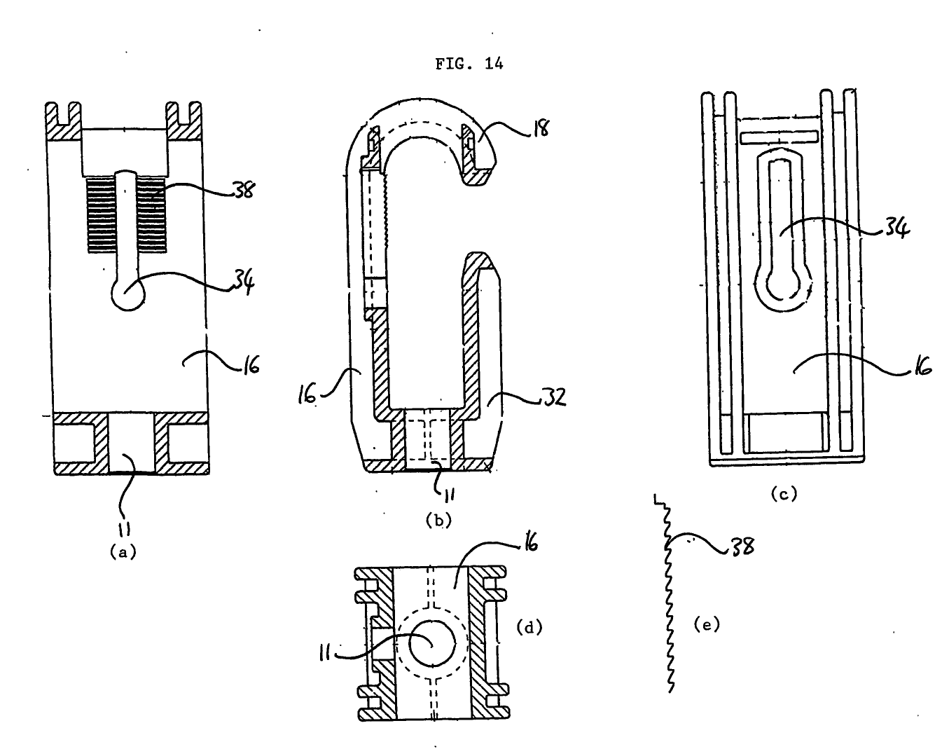

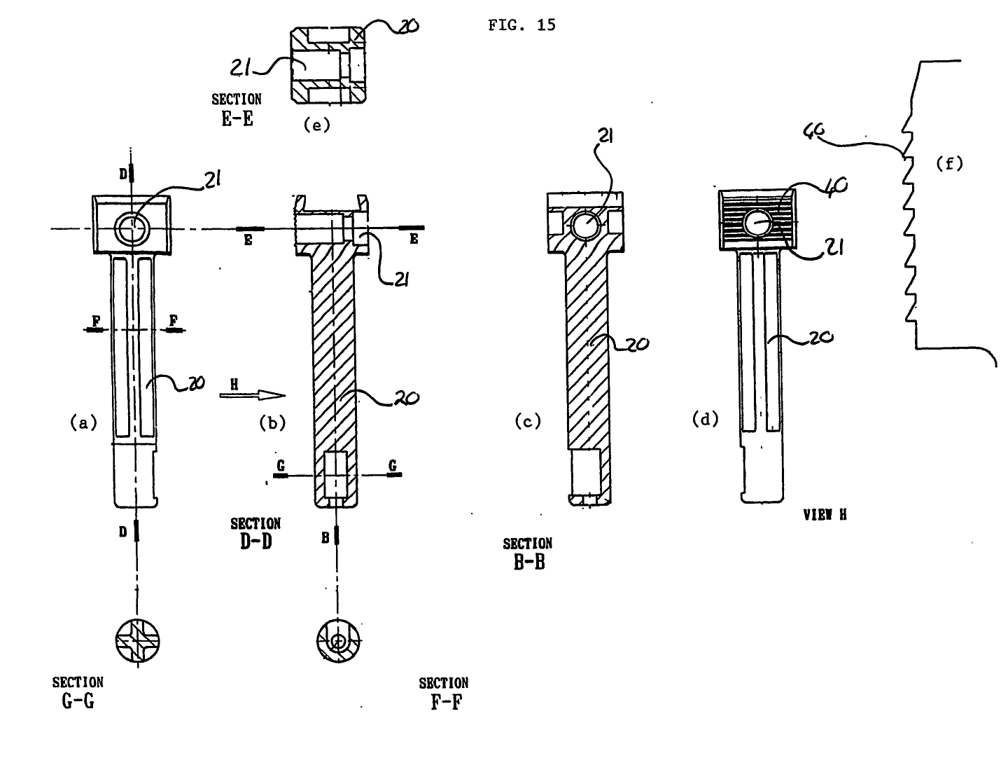

FIG. 14[a-e] shows various aspects of the first member with [a] being a view of the back aspect the first member, [b] a cross section of the first member, [c] a back view of the first member, [d] a partial cross section of the bottom aspect of the first member and [e] a representation of the ratchet;

FIG. 15[a-f] show various aspects of the second member with [a] being a plan view, [b] being a section on D-D, [c] a section through on B-B, [d] a view on aspect H, [e] a section on E-E and [f] depicting the ratchet on the second member; and

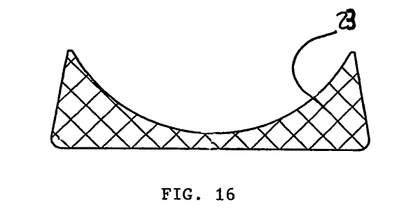

FIG. 16 a section through a part of the second member of a particular embodiment.

In the drawings, reference numeral 10 generally refers to the bird deterring device.

A device 10 for deterring birds from overhead cables [not shown] such as power lines, which device includes at least one vane set 12, rotatably attached to a clamping means 14 for clamping the device 10 on the power line.

The clamping means 14 has a first member 16 having a hook portion 18 for hooking over the power line and a second member 20 biased towards the hook portion 18, and the biased member 20 includes a biasing means in the form of a spring 22. The first 16 and second 20 members are displaceable between a first position [not shown] when the spring 22 is loaded and a second clamped position [not shown] thereby clamping the power line between the first member 16 and the hook 18 in the second clamped position. FIG. 1 shows the second member 20 between the first and second position.

The vane set 12 has a fluorescent covering that increases the visibility of the vanes to the birds and are coloured so as to be effective day and night.

In an embodiment [not shown], the vane set includes a reflective covering.

The vanes 12 are configured to rotate in response to the wind and/or vibrations from the power line. The rotation accentuates the reflective covering as well as the alternative black and white colouring.

The vanes 12 are rotatably attached to the clamping means 14 by a suspension means 24.

The suspension means 24 is in the form of a small rod and is rotatably attached to the vanes 12, as well as the clamping means 14.

The second member 20 includes a securing means 26 configured to keep the second member 20 in either the first or second position. In the preferred embodiment, the securing means 26 has a head 28 and a pin 30.

The second member 20 includes a soft portion insert 23 that assists in clamping the clamping means 14 on the cable. The soft portion 23 inhibit damage to the cable.

The first member 16 is substantially C-shaped and has a lower section 32 of the C-shape configured to house the second member 20 in the first position when the spring 22 is loaded.

The upper section 18 of the C-shape is the hook portion 18 for hooking over the power line.

At least a part of the hook portion may include a soft portion that assists in clamping the clamping means on the cable.

The first member 16 has a soft insert 16 in the hook portion 18 that inhibit damage to the cable when in the clamped position.

The first member 16 includes a slot 34 for receiving the securing means 26 of the second member 20. The second member 20 has an aperture 21 for receiving the pin 30 of the securing means 26 therethrough. When the head 28 of the securing means 26 is turned in the lower part of the slot 34, the securing means engages the second member 20 and keeps the spring 22 in a loaded condition. Turning the head 28 of the securing means 26 disengages the securing means 26 from the second member 20 and the spring 22 forces the second member towards the hook 18. In the preferred embodiment, the securing means 26 has a spring 36 that assists with the disengagement of the securing means 26 from the second member 20.

The securing means 26 is configured to be released from the first position by remote activation. It is to be appreciated from this specification that the activation can be manual, but preferable by remote operation due to the inherent dangers of working with power lines. Remote activation would typically be done by a vehicle [not shown] moving along the length of the lines the is remotely drive and has a mechanism for turning the head 28 of the securing means 26 when the device is at the desired position on the line.

The first member 32 has a ratchet 38 configured to assist in keeping the second member 22 in the second position. A corresponding ratchet 40 is found on the second member 20.

Soft inserts 19 and 23 inhibit rotation of the device 10 on the overhead cable and minimize damage to the cable.

1. A device for deterring birds from overhead cables such as power lines, which device includes:
a clamping means for clamping the device on the overhead cable, the clamping means including
a first member having a hook portion for hooking over the power line; and
a second member biased towards the hook portion, wherein said biased member includes a biasing means; and
at least one vane set rotatably attached to the clamping means wherein the first and second members are displaceable relative to each other between a first loaded position, wherein the biasing means is loaded, and a second clamped position, wherein the biasing means is at least partially unloaded thereby clamping the power line between the first member and the second member.

2. A device as claimed in claim 1, wherein the vane set is fluorescent thereby to increases the visibility of the vanes to the birds.

3. A device as claimed in claim 1, wherein the vanes of the vane set are alternatingly coloured with a first colour and a second colour thereby to be visible to the birds both by day and by night

4. A device as claimed in claim 1, wherein the vane set is reflective.

5. A device as claimed in claim 1, wherein the vanes are configured to rotate in response to the wind.

6. A device as claimed in claim 1, wherein the vanes are configured to rotate in response to vibrations from the power line.

7. A device as claimed in claim 1, wherein the vanes are rotatably attached to the clamping means by a suspension means.

8. A device as claimed in claim 7, wherein the suspension means is in the form of a rod.

9. A device as claimed in claim 7, wherein the suspension means is in the form of a flexible rod which is rotatably attached at one end region to the clamping means and at its other end region to the vane set.

10. A device as claimed in claim 1, wherein the biasing means includes a spring.

11. A device as claimed in claim 1, wherein the second member includes a securing means configured to keep the second member in the first position ready for clamping onto the overhead cables

12. A device as claimed in claim 1, wherein the second member includes a securing means configured to keep the second member in the second clamped position.

13. A device as claimed in claim 1, wherein the first member is substantially C-shaped.

14. A device as claimed in claim 13, wherein the lower section of the C-shape is configured to house the second member in the first position when loaded.

15. A device as claimed in claim 13, wherein the upper section of the C-shape is the hook portion for hooking over the overhead cable.

16. A device as claimed in claim 1, wherein the first member includes a slot for receiving the securing means of the second member.

17. A device as claimed in wherein the securing means is configured to be released by remote activation.

18. A device as claimed in claim 1, wherein the first member includes a ratchet configured to assist in keeping the second member in the second clamped position.

19. A clamping means for clamping objects to overhead cables such as power lines, said clamping means including;
a first member having a hook portion for hooking over the overhead cable;
a second member biased towards the hook portion; and
biasing means for biasing the second member towards the hook portion; and
wherein the first and second members are displaceable relative to each other between a first loaded position, wherein the biasing means is loaded, and a second clamped position, wherein the biasing means is at least partially unloaded thereby clamping the power line between the first member and the second member.

20. A clamping means as claimed in claim 19, wherein the biasing means of the second member includes a spring.

21. A clamping means as claimed in claim 19, wherein the second member includes a securing means configured to keep the second member in either the first or second position.

22. A clamping means as claimed in claim 19, wherein the first member is substantially C-shaped.

23. A clamping means as claimed in claim 22, wherein the lower section of the C-shape is configured to house the second member in the first position when loaded.

24. A clamping means as claimed in claim 22, wherein the upper section of the C-shape is the hook portion for hooking over the cable.

25. A clamping means as claimed in claim 19, wherein the first member includes a slot for receiving the securing means of the second member.

26. A clamping means as claimed in claim 21, wherein the securing means is configured to be released from the first position by remote activation.

27. A clamping means as claimed in claim 19, wherein the first member includes a ratchet configured to assist in keeping the second member in the second position.

28. A device for deterring birds from overhead cables such as power lines, which device includes at least one vane set.

29. A device as claimed in claim 28, wherein the vane set is fluorescent thereby to increase the visibility of the vanes to the birds.

30. A device as claimed in claim 28, wherein the vanes of the vane set are alternatingly coloured with a first colour and a second colour thereby to be visible to the birds both by day and by night

31. A device as claimed in claim 28, wherein the vane set is reflective.

32. A device as claimed in claim 28, wherein the vanes are configured to rotate in response to the wind.

33-47. (canceled)

48. A device as claimed in claim 29, wherein the vanes are configured to rotate in response to vibrations from the power line.

49. A device as claimed in claim 29, wherein the vanes are rotatably attached to a clamping means by a suspension means.

50. A method of deploying a clamping means including;
a first member having a hook portion for hooking on to the cable;
a second member biased towards the hook portion; and
biasing means for biasing the second member toward the hook portion wherein the first and second members are displaceable relative to each other between a first loaded position, wherein the biasing means is loaded, and a second clamped position, wherein the biasing means is at least partially unloaded thereby clamping the power line between the first member and the second member, said method including;
hooking the clamping means onto the cable; and
actuating the displacement of the first and second members relative to each other.

51. A method as claimed in claim 36, wherein the biasing means of the second member includes a spring.

52. A method as claimed in claim 35, wherein the second member includes a securing means configured to keep the second member in either the first or second position, which securing member is released thereby actuating the relative displacement of the first and second members.

53. A method as claimed in wherein the actuation of the displacement of the first and second members relative to each other is by remote control.
